(19) United States
(12) Patent Application Publication
(10) Pub. No.: US 2017/0236039 A1
(43) Pub. Date: Aug. 17, 2017

(54) Method & Apparatus for Automatic Design, Layout & Pre-Press for Photo Book

(71) Applicants: Andrew M. FUNDERBURG, Beaverton, OR (US); William CAMPBELL, Beaverton, OR (US); Jonathan D. STICKLES, Beaverton, OR (US)

(72) Inventors: Andrew M. FUNDERBURG, Beaverton, OR (US); William CAMPBELL, Beaverton, OR (US); Jonathan D. STICKLES, Beaverton, OR (US)

(73) Assignee: Fundy Software Inc., Beaverton, OR (US)

(21) Appl. No.: 15/075,185

(22) Filed: Mar. 20, 2016

Related U.S. Application Data
(60) Provisional application No. 62/295,361, filed on Feb. 15, 2016.

(51) Int. Cl. G06K 15/00; G06F 17/21; G06K 15/02

(52) U.S. Cl. CPC G06K 15/007; G06K 15/025; G06F 17/218

(57) ABSTRACT

Embodiments of the invention assist a human pre-press operator or designer to produce layouts of photos in a multi-page book. Some embodiments operate autonomously, given only high-level configuration parameters such as number of pages and number of images. Other embodiments operate interactively, preparing an automatic layout and then accepting manual adjustments to the selection of images and their arrangement on the pages. An embodiment may produce a computer-readable medium for use in a subsequent printing process, or may produce the finished printed book itself.

### CONTINUITY AND CLAIM OF PRIORITY

This is an original U.S. patent application that claims priority to U.S. provisional patent application 62/295,361 filed 15 Feb. 2016.

### FIELD

The invention relates to prepress design and layout. More specifically, the invention relates to automatic methods for selecting, arranging and laying out sets of rectangular images to produce a target number of pages for printing.

### BACKGROUND

In the past, photo albums and picture books were the product of a labor-intensive series of manual manipulations of physical objects: a photographer would capture images onto film; the film would be developed to produce negatives; the negatives would be printed onto paper; and the paper photos would be arranged onto a page for delivery or for further operations leading to printing (e.g., offset printing) of multiple copies of the page. The process would often include cropping or resizing of photos to obtain an attractive, balanced composition, and for low-volume production, layout often involved cropping or resizing to match pre-cut windows in a mat board (rather than cutting custom mats to suit an arbitrary layout of ideally-cropped and -sized images on the page). Thus, in addition to the involved manual process, the result was often constrained by the number and configuration of pre-cut mats: a designer laying out three images on a page might have only two or three different options for photo position, size and aspect ratio. (The alternative of cutting arbitrary custom mats for each page is prohibitively expensive for many projects.)

With the development of digital photography and high-bandwidth data connections among devices (such as via the Internet), photos are now more commonly shared one at a time or in an array or slide show on a transient display device such as a multi-pixel screen (e.g., an LCD monitor, a laptop screen, a tablet device or an electronic picture frame), and/or via other impermanent distribution mechanisms such as website galleries. However, consumers still desire permanent physical copies of some photo sets, such as wedding albums, graduation pictures and childhood memories books. And although many of the photos in such physical albums are often created through a digital process, the facilities for laying out the photos into printable spreads still emulate the traditional “template” model, where the designer must select from among a small number of arrangements and photo sizes matching the number of photos to be displayed on the page. (Or alternatively, the creator of the photo layout software must produce an enormous number of templates with different layouts, sizes and aspect ratios for each number of photos on a page, and the designer must be familiar with large template libraries to achieve the desired effect.) Either way, simply replicating traditional paper-based photo layout procedures into software does not take advantage of the flexibility and power that computer-based layout could offer, and does not yield the labor (and cost) savings that might be expected.

Automatic page layout processes such as those described in U.S. Pat. No. 9,116,648 can streamline part of the work to prepare each page of a photo book, but the overall task still presents opportunities for automation beyond simply repeating the page layout for each page. Methods, software and systems to automate more of the prepress process may be of significant value in this field.

### SUMMARY

Systems and methods for assisting or fully automating the process of selecting images from a library, grouping them into related subsets and arranging each subset on a single- or double-size page for printing and binding produce a computer-readable medium containing data and instructions to drive an electronically-controlled printer.

### BRIEF DESCRIPTION OF DRAWINGS

FIG. 1 shows an overview of a method performed by an embodiment of the invention.

FIG. 2 shows an example of metadata that may be associated with an image, which can be used by an embodiment of the invention.

FIG. 3 shows an environment including several devices and communication channels, where the devices are able to cooperate in implementing an embodiment of the invention.

FIG. 4 shows how an embodiment can combine manual and automatic processes to accomplish the goal of producing a photo album layout.

FIG. 5 outlines a workflow to show interactions between manual and automatic operations of an embodiment.

### DETAILED DESCRIPTION

Embodiments of the invention extend the span of automated activity in the process of producing layouts for multiple pages of a photo album. An embodiment may use heuristics to select photos from a library of media for inclusion on a page, and then use a known automatic layout process to complete the composition for the page. The automatic selection and layout are repeated for successive pages. Thus, starting with a library of images and a small number of configuration parameters, an embodiment can produce a complete, ready-to-print album, represented as data and instructions on a computer-readable medium that can be processed by an electronic printer.

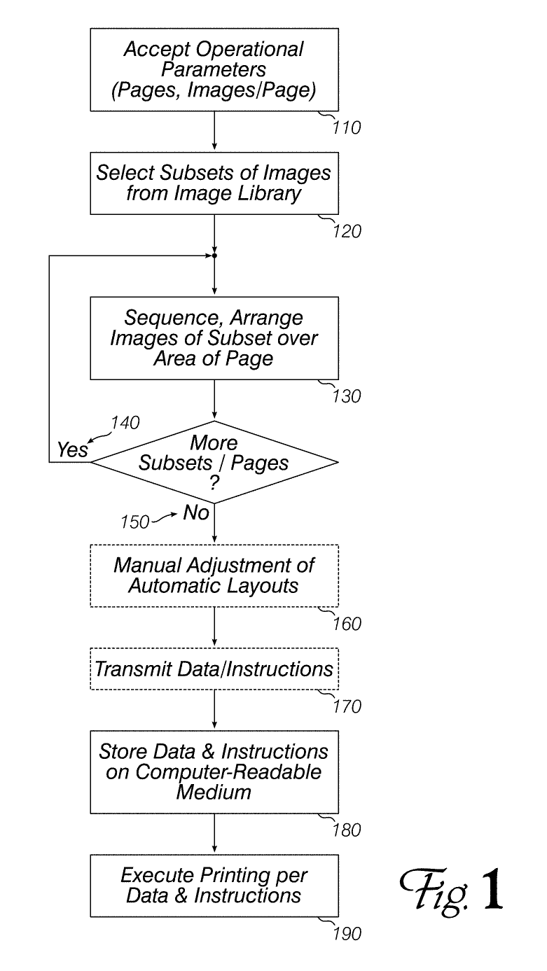

FIG. 1 is a flowchart outlining the main operations of an embodiment of the invention. First, the user enters operational parameters, including (for example) a target number of pages and a target number of total images for the photo book that the embodiment is to automatically design (110). (Note that these configuration parameters may give a non-integral number of images per page, i.e., NumberOfPages÷NumberOfImages has a fractional portion. However, since there is a whole number of images on each page, these configuration parameters leave room for the algorithm to lay out pages with slightly varying numbers of images per page, so long as the total number of images in the book meets the target parameter. Other embodiments may accept different parameters, such as a target number of pages and a number of images per page.)

Next, the embodiment selects multiple subsets of images from a library of images (120). Details of the image selection process will be discussed below. Now, for each subset of images, the images are sequenced or ordered and arranged to cover substantially all of a roughly rectangular image area of a page (130). If there are more image subsets to process (140), the embodiment repeats the sequencing and arranging operations. Otherwise (150), the user may be offered an opportunity to review or modify the automatically-selected and -laid-out pages (160). (In some embodiments, user interaction may be made part of the page layout loop, and image-selection or arrangement alterations may affect subsequent automatic image subset selections and layout operations.)

Once the image selections and arrangements have been finalized, data and instructions reflecting the final product may be transmitted to a service bureau for further processing (170). Whether transmitted elsewhere or not, the data and instructions are recorded on a tangible computer-readable medium (180).

Finally, the recorded data and instructions are provided to a computer-controlled printing process to cause an output device to produce a plurality of physical pages containing the selected subsets of images (190). These pages are typically bound together using conventional methods to produce a copy of the desired photo book. The printing process can be repeated as desired to produce several substantially-identical copies of the book.

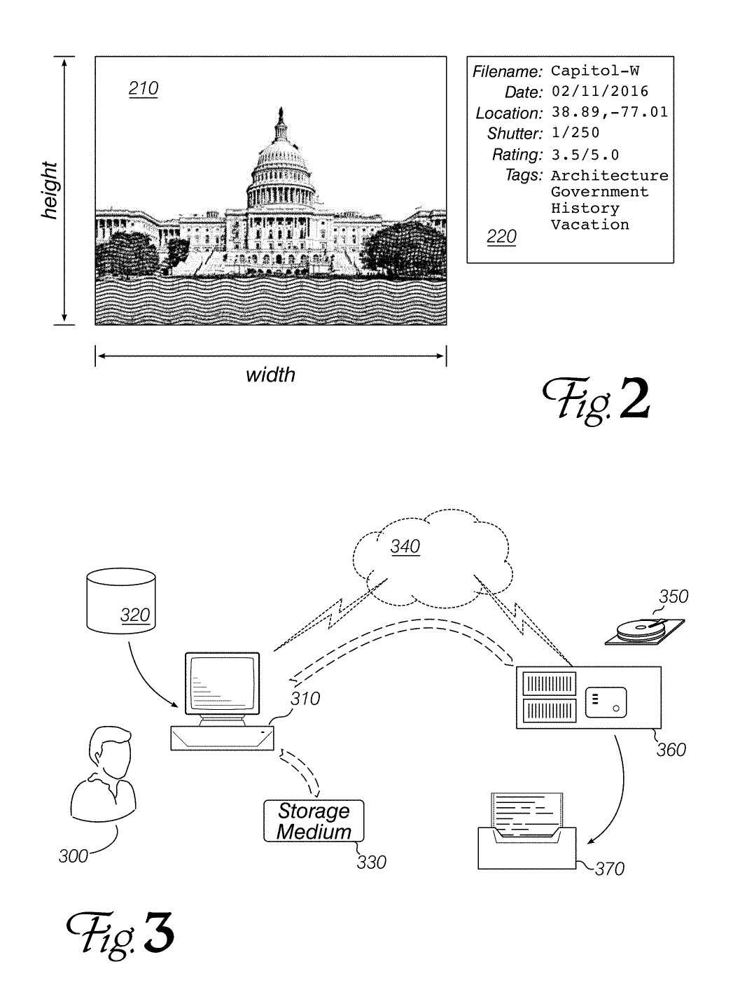

FIG. 2 shows a representative image 210 that might be included in an image library and selected for printing in an automatically-laid-out photo book. Embodiments typically work with rectangular, rasterized images, although non-rectangular images and other image representations can be adapted by treating the rectangular bounding box of the image as setting the relevant width and height dimensions. In addition to the graphical image data that may be included in a photo book, images in the library are associated with metadata 220. The metadata may not be apparent in the printed representation of the graphical image data, but it can be used by an embodiment of the invention to improve image selection and layout. Metadata may include information such as a file name, a date on which the image was created or modified, a location where the image was created or where the depicted subject may be found, or information about the camera settings used to capture the image. These sorts of information may be automatically collected and maintained by the devices involved in acquiring and storing the image.

Image acquisition, editing and management systems often permit the association of additional sorts of information with the images. This type of metadata (called “tags”) is often manually added, and may include things such as a rating (reflecting aesthetic judgments such as compositional quality, lighting, subject interest and so forth); or tags specified as words or phrases associated with the image. For the image shown in FIG. 2, tags might include “architecture,” “government,” “history” or “vacation.” Other image libraries might include images having different tags. For example, photos for a wedding album might include tags giving the names of subjects depicted or phases or events associated with the wedding, such as “bachelor party,” “rehearsal dinner,” “day of wedding,” “groom getting ready,” “bride getting ready,” “first kiss,” etc. Many image-management systems allow the assignment of arbitrary tags, and embodiments of the invention can work with arbitrary tags as long as they can be compared for equality. (Some tags or other metadata may also be compared quantitatively. For example, the “date” fields can be compared to determine which of two images was captured or produced earlier in time.)

In addition to the “semantic” tags discussed in the preceding paragraph (i.e., tags that relate to the people, places and/or events depicted in the tagged image), an embodiment also relies on “structural” tags, which provide information to help the automatic layout process produce an aesthetically pleasing arrangement of the images on each page. Structural tags may include, for example, “panorama” to mark a short, wide image that should be placed to extend over the full width of a page, or over a two-page spread; “main” to mark an image that should be prominent, occupying a full page by itself or a large proportion of a multi-image page; or “cover” to mark images that are eligible to be chosen for book covers or section separators. These two types of tags (“semantic” and “structural”) may be applied and managed by prior-art tagging systems that accept arbitrary tag text, but they are treated differently by embodiments of the invention. In addition, some structural tags may be applied automatically. For example, “panorama” photos can be automatically recognized by their dimensions: a width-to-height ratio exceeding about 3:1 is likely to be a panorama-class image. And “main” images may be tentatively identified by high “favorite” or “like” scores (i.e., high subjective ratings by many reviewers).

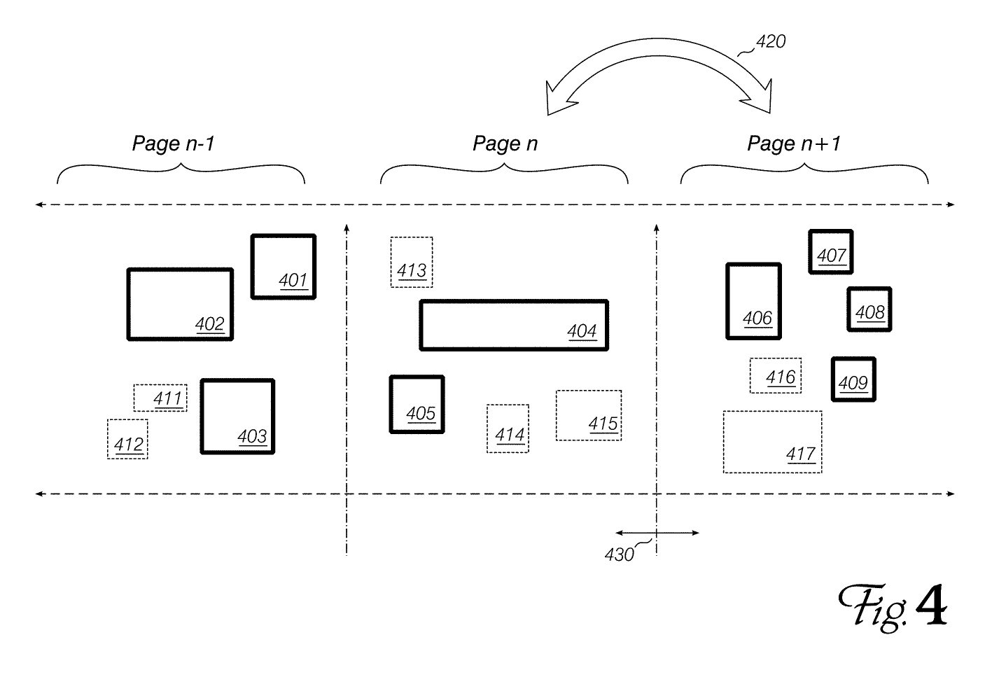

FIG. 3 shows some of the actors and machines that interact during the operation of an embodiment. A user 300 operates a computer 310 which executes according to data and instructions that cause the computer to perform methods like that outlined in FIG. 1. Computer 310 has access to an image library 320, which typically includes both graphical information as well as image metadata (i.e., semantic and structural tags).

User 300 provides operational target parameters, and software causes computer 310 to select images from library 320 and arrange them on a plurality of pages. The user may adjust these selections and arrangements, and eventually data and instructions to describe the layout are stored on a tangible computer-readable medium such as a CD-ROM or flash drive 330. (Alternatively, the data and instructions may be transmitted, e.g. via a distributed data network 340 such as the Internet, to another computer 360 where they may be stored on a tangible computer readable-medium such as hard disk 350.)

Eventually, the data and instructions describing the photo book are processed and sent to a printer 370 to cause the printer to produce corresponding pages for the book. The printer performs operations such as preparing a rasterized image representing a page according to the data and instructions and transmitting the rasterized image data to a printing mechanism to reproduce the image on a tangible medium such as a sheet of paper. Those media (pages) may be bound according to traditional bookbinding processes.

As discussed earlier, an embodiment automatically selects subsets of images chosen from the library of images, according to configuration parameters provided by the operator. At a minimum, the operator should specify the number of pages desired in the photo book, and the total number of images to be used. (Typically, selected images are grouped into subsets containing approximately the same number of images, where each subset of images corresponds to one page of the book. However, it is appreciated that the automatic rectangular-area layout method of U.S. Pat. No. 9,116,648 can be operated recursively to fill one rectangular frame with a second “child” plurality of images, so the child plurality of images might form a distinct subset.)

The automatic activities of an embodiment of the present invention comprise two distinct tasks: first, a group of images must be selected, and then an order for the images must be chosen. (In a preferred embodiment, both selection and ordering can be adjusted manually after the automatic process has run. Even if an embodiment provides little manual control, it is preferable to have at least a “retry” or “randomize” option to cause the algorithm to select a different group of images, or to order them differently.)

A number of strategies may be suitable for selecting a subset of images:
Select images having a particular semantic tag (such as “wedding dress” or “honeymoon”).
Select images having timestamps falling within a suitable range (where the range may be inversely proportional to the number of images in the library).
Select images having geographic locations falling within a suitable distance from each other.
Select images having different values for a metadata field (e.g., for the “name” or “identification” field, selecting different values will help ensure that all the people whose pictures are present in the library will be represented on a page or in the photo book).
Select images having high aesthetic ratings (such ratings may have been manually assigned by the photographer, by the client and/or by individuals invited to review the photographs, including their subjects).
Selected images appear only once in all of the subsets of images.
Some images may appear in multiple subsets (i.e., they may appear on multiple pages, albeit possibly in different locations on the page or with different scaling).

Combination strategies may be helpful in some situations. For example, once “rehearsal dinner” images have been selected, diverse “name” or “identification” fields may be sought so that everyone who attended the rehearsal dinner will be depicted together on the same page (or on facing pages).

User interfaces for interacting with the automatic selection and layout process may permit the selection of arbitrary groups of images, in a manner similar to the assignment of common semantic tags. For example, an otherwise-meaningless tag such as “XYZ8294” may be applied to a group of images, and the selection process may choose the tagged images on the basis of this common tag, just as it might choose images with a meaningful tag such as “day of wedding” or “first kiss.”

Once subsets of images containing near the configured target number of images have been chosen, a second strategy may be employed to determine the left-to-right and/or top-to-bottom order in which the images appear on each page. For example:
Images may be ordered by time of creation.
Images may be ordered by location to produce the smoothest path from location to location.
Images may be ordered to minimize (or maximize) image-to-image shutter speed variation.
Images may be ordered randomly.
Images may be ordered by increasing, decreasing or randomized aspect ratio.
Certain images may be positioned and/or sized manually, and automatically-placed images may be arranged to fill remaining empty space.

Finally, each selected subset is provided to the automatic page-layout algorithm to generate data and instructions to permit a programmable printer to reproduce the laid-out page. As explained earlier, this process may be influenced by the presence of structural tags on the images. For example, “panorama” tags may cause the layout algorithm to place images thus tagged on a row by themselves so they span the distance from margin to margin (or fully across a two-page spread). Similarly, “main” tagged images may be scaled to occupy more of the printable area than other auxiliary images on the same page. Once the data and instructions produced through the automatic-layout process of an embodiment are stored on a computer-readable medium, they can be used in conventional printing processes, in place of the layouts prepared by prior-art all-manual processes.

It is appreciated that pages of a book are typically about the same size, and each layout may extend over substantially all of the page. However, for facing pages, the layout may cover twice the width (or height) of a single page. Facing-page layouts may provide an opportunity to place images with unusually-wide or -tall aspect ratios, such as panoramic photos.

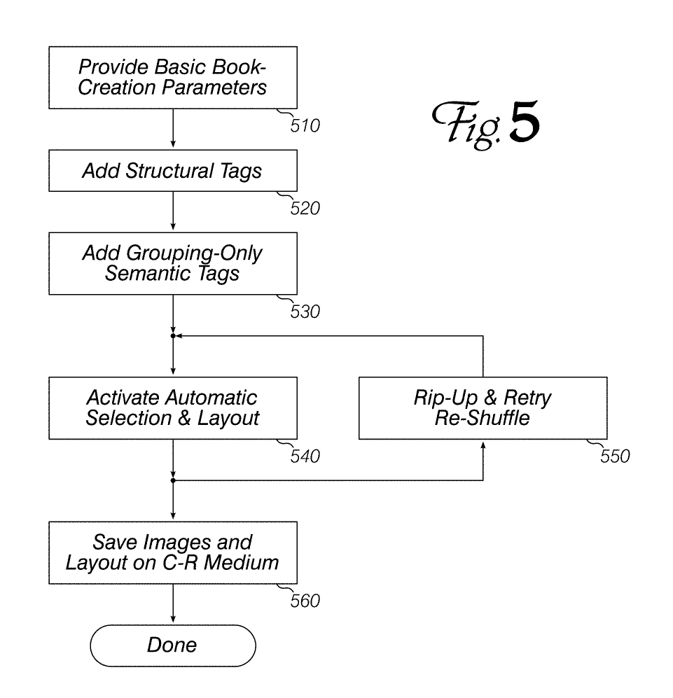

As embodiments interoperate with and complement what is traditionally a high-touch, artistic workflow involving extensive human judgment, a preferred embodiment may be used to supplement or “fill in” details around a manual selection or arrangement of the principal images in a photo book. For example (referring to FIG. 4) the operator can select groups of “centerpiece” images (heavy-framed rectangles 401-409; these may correspond to the “main” structural tag) and engage an embodiment to select supplemental images (light, dashed-frame rectangles 411-417) to fill in the pages and satisfy the target number of pages and images. Controls may be provided to make manual changes, such as switching the order of pages 420, or adjusting the number of images per page (e.g., dragging a control 430 to the left may decrease the number of automatically-selected images for the left-hand page layout, and increase the number selected for the right-hand layout). A partially-automatic, partially interactive interface may provide features like those described above: to select different images (other than manually-selected centerpiece images) for one or more pages, to rearrange images on one or more pages, to place more or fewer images (out of the total target number) on a page, or to resequence pages entirely. The automatic portions of a hybrid manual/automatic process can increase the operator's productivity, allowing him to complete more page or book layouts in the same amount of time.

When several key or “centerpiece” images have been manually selected, the “repeat automatic image selection” process may attempt to select additional images to complete the image subset for the page based on semantic tags of the key images. For example, if all of the key images share a tag, location or time, then auxiliary images having the same tag, location or time may be chosen to fill out the page. A “randomize” or “shuffle” control may cause the selection of images having a different characteristic in common with the key images.

FIG. 5 shows some manual actions an operator of an embodiment may perform to influence the automatic actions of the embodiment. These have all been discussed at various points in the preceding material, but are consolidated here for ease of reference. One of the first things an operator of an embodiment will do is provide basic configuration parameters (510) such as a target number of pages and a target total number of images. Structural tags may also be manually applied to certain images (520). (Other structural tags may be automatically applied.)

Arbitrary subsets of images may be manually selected and tagged together with a semantic tag whose sole purpose is to allow the automatic selection process to choose images from the arbitrary subset (530). These tags are similar in operation to human-meaningful semantic tags like “bouquet toss” or “first dance,” but do not have a meaning beyond “these images go together (for some reason).” An automatic layout cycle may be performed (540), and the operator may invoke a re-try or re-shuffle command to cause the system to choose different images or arrange them on the pages differently (550). Part of this loop may include adding, deleting or changing semantic or structural tags on images to adjust the automatic operations of the layout process.

Finally, when an acceptable layout has been produced, data and instructions representing the images and layout are recorded onto a tangible, computer-readable medium for use in subsequent printing operations (560).

An embodiment of the invention may be a machine-readable medium, including without limitation a non-transient machine-readable medium, having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a non-transient machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that automatic photo selection and layout for pre-press can also be accomplished by software and hardware that distribute the functions of embodiments of this invention differently than herein described. Such variations and implementations are understood to be captured according to the following claims.

We claim:

1. A method for manufacturing a non-transitory computer-readable medium containing data and instructions to cause a programmable printing machine to produce tangible pages for a photo book, comprising:
accepting operational parameters including at least a number of pages and a target total number of images;
selecting a plurality of subsets of images from a catalog of images, a number of said selected subsets equal to the number of pages and all of said selected subsets together including approximately the target total number of images;
for each selected subset, applying an automatic layout algorithm to arrange all images of the selected subset so as to occupy substantially all of an area of a page; and
storing output data corresponding to the selected images and an output of the automatic layout algorithm on a non-transitory computer readable medium, said output data sufficient to permit a programmable printing machine to produce tangible pages corresponding to the selected subsets of images and the arrangements of the automatic layout algorithm.

2. The method of claim 1 wherein an image from the catalog of images comprises a semantic tag relating to a content of the image, and a structural tag relating to a layout of the image on a page.

3. The method of claim 2 wherein the structural tag indicates one directive chosen from:
place this image on a cover of the photo book;
place this image alone on a horizontal row of a page;
place this image alone on a horizontal row of a two-page spread; or
place this image so that its printed area exceeds a printed area of all other images on a same page.

4. The method of claim 1, further comprising:
providing the data on the non-transitory computer-readable medium to a programmable printing machine; and
printing a plurality of tangible pages, a number of said tangible pages equal to the number of pages accepted as an operational parameter.

5. The method of claim 1, further comprising:
accepting an identification of a group of images from the catalog of images; and
applying a common semantic tag to each image of the group of images to form a linked group of images, said common semantic tag serving only to associate the images of the linked group together, and wherein
selecting a plurality of subsets of images comprises selecting at least one subset of images chosen from the linked group of images.

6. The method of claim 1 wherein each image in the catalog of images comprises a plurality of standard tags, the method further comprising:
accepting a nonstandard tag to be associated with a subset of the images in the catalog of images, and wherein
selecting one of the plurality of subsets of images from the catalog of images comprises selecting some of the images that were associated with the nonstandard tag.

7. The method of claim 1, wherein a first area of a first page is approximately half of a second area of a second page.

8. The method of claim 1, further comprising:
displaying images of a selected subset as arranged by the automatic layout algorithm on a transitory display device;
receiving a selection of an unwanted one of the images of the selected subset and a different substitute image from the catalog of images; and
altering an output of the automatic layout algorithm to replace the unwanted one of the images with the different substitute image before storing output data and the output of the automatic layout algorithm on the non-transitory computer readable medium.

9. The method of claim 1, further comprising:
displaying images of a selected subset as arranged by the automatic layout algorithm on a transitory display device;
receiving a shuffle trigger;
repeating application of the automatic layout algorithm to arrange all of the images of the selected subset so as to occupy substantially all of the area of the page, said repeated application to produce a different arrangement of the selected subset of images.

10. The method of claim 1, further comprising:
altering the output of the automatic layout algorithm to change an order of pages to be produced by the programmable printing machine before storing the output of the automatic layout algorithm on the non-transitory computer readable medium.

11. A computer-aided prepress method, comprising:
accepting a first configuration parameter to control a total number of pages;
accepting a second configuration parameter to control a total number of images;
selecting a plurality of subsets of images from a library of images, a number of said subsets equal to the total number of pages and a total number of images in all of said subsets equal to the total number of images;
arranging images of each of the plurality of subsets of images to occupy substantially all of a page corresponding to each subset; and
recording data and instructions to represent the arrangement of the images on each page, onto a tangible, non-transitory computer-readable medium.

12. The computer-aided prepress method of claim 11 wherein no image from the library of images appears in more than one subset of the plurality of subsets.

13. The computer-aided prepress method of claim 11 wherein at least one image from the library of images appears in at least two subsets of the plurality of subsets.

14. The computer-aided prepress method of claim 11 wherein the selecting, arranging and recording operations proceed sequentially and without manual interruption.

15. The computer-aided prepress method of claim 11, further comprising:
manually adjusting an identification of images in one of the plurality of subsets of images; and
repeating the arranging operation before performing the recording operation.

16. The computer-aided prepress method of claim 11, further comprising:
manually adjusting a position of an image on one of the pages corresponding to a subset of images; and
repeating the arranging operation before performing the recording operation.

17. A non-transitory computer-readable medium containing data and instructions to cause a programmable processor to perform operations comprising:
displaying a plurality of images from a catalog of images on a transitory display device, each of said images having associated therewith a non-visual metadata value;
accepting a user grouping of a subset of the plurality of images from the catalog of images to create a related group including a plurality of images;
automatically compositing a first page including images from the related group, said compositing to determine ordering and scaling so that the images from the related group cover substantially all of the first page;
repeating the automatically compositing operation to produce a second arrangement of images from the catalog of images, said second arrangement of images to cover substantially all of a second page; and
storing printable data comprising data and instructions corresponding to the images from the related group, the images from the catalog of images, the ordering and scaling from the first automatic compositing operation and the second arrangement of images from the catalog of images on a non-transitory computer-readable medium.

18. The non-transitory computer-readable medium of claim 17 wherein the automatically-composited first page includes some but not all of the images from the related group.

19. The non-transitory computer-readable medium of claim 17, containing additional data and instructions to cause the programmable processor to perform operations comprising:
transmitting the printable data to a remote computer via a distributed data connection, wherein
the storing printable data operation is performed by the remote computer.

20. The non-transitory computer-readable medium of claim 17, containing data and instructions to cause the programmable processor to perform operations comprising:
preparing a rasterized image according to the printable data, said rasterized image representing the first page; and
transmitting the rasterized image to a printing device to be reproduced on a tangible medium.
